(19) United States
(12) Patent Application Publication
(10) Pub. No.: US 2018/0313120 A1
(43) Pub. Date: Nov. 1, 2018

(54) Bathroom-Stall Door Stop

(71) Applicant: Vinod Mahadeo, Margate, FL (US)

(72) Inventor: Vinod Mahadeo, Margate, FL (US)

(21) Appl. No.: 15/968,645

(22) Filed: May 1, 2018

Related U.S. Application Data
(60) Provisional application No. 62/492,720, filed on May 1, 2017.

(51) Int. Cl. E05C 19/18

(52) U.S. Cl. CPC E05C 19/182

(57) ABSTRACT

A bathroom-stall door stop that prevents a user from entering a bathroom stall that is out-of-service. The bathroom-stall door stop includes a first panel, a second panel, and a cross plate. The first panel, the second panel, and the cross plate form a structural shape that can be placed in between a bathroom-stall door and frame. When the bathroom-stall door stop is placed between the bathroom-stall door and frame, the bathroom-stall door stop obstructs the hinged connection of a bathroom-stall door which further prevents a user from opening the bathroom-stall door. Furthermore, when the bathroom-stall door stop is placed between the bathroom-stall door and frame, the first panel is positioned adjacent to the exterior of the bathroom-stall door, the second panel is positioned adjacent to the interior of the bathroom-stall door, and the cross plate is positioned adjacent to the hinged connection between the bathroom stall door and frame.

The current application claims a priority to the U.S. Provisional Patent application Ser. No. 62/492,720 filed on May 1, 2017.

### FIELD OF THE INVENTION

The present invention relates generally to door stops. More specifically, the present invention is a bathroom-stall door stop that prevents a user from entering an out-of-service bathroom stall.

### BACKGROUND OF THE INVENTION

A bathroom or restroom is a room designated for personal hygiene activities and primarily for a person to urinate or defecate. Public buildings usually include bathrooms or restrooms with multiple bathroom or restroom stalls which allows multiple users to urinate or defecate. This is very convenient for the public, but unfortunately these bathroom or restroom stalls may go out of order. When a bathroom or restroom stall does unfortunately go out of order, the maintenance faculty is responsible for preventing users from utilizing the bathroom or restroom stall. There are two common methods of doing such, which includes either having a person crawl under the bathroom or restroom stall door, locking it from the inside, and then crawling back outside or by placing an “out of service” sign on the out of service bathroom or restroom door. The first method is bothersome, and the second method does not always work because a person can simply ignore or miss the “out of service” sign.

It is therefore an objective of the present invention to provide a bathroom-stall door stop that prevents a user from utilizing an out-of-service bathroom stall. The present invention is easily used by simply placing the present invention between a bathroom stall-door and frame. This obstructs the hinged connection between the bathroom-stall door and frame which further prevents a user from opening the bathroom-stall door. The present invention may include a sign aspect which visually represents that the bathroom stall is out of service rather than a person figuring that out by attempting to open the bathroom-stall door.

### BRIEF DESCRIPTION OF THE DRAWINGS

FIG. 1 is a front perspective view of the present invention.

FIG. 2 is a rear perspective view of the present invention.

FIG. 3 is a side view of the present invention.

FIG. 4 is a side perspective view of the present invention.

FIG. 5 is a front perspective view of an alternative embodiment of the present invention.

FIG. 6 is a rear perspective view of an alternative embodiment of the present invention.

### DETAIL DESCRIPTIONS OF THE INVENTION

All illustrations of the drawings are for the purpose of describing selected versions of the present invention and are not intended to limit the scope of the present invention.

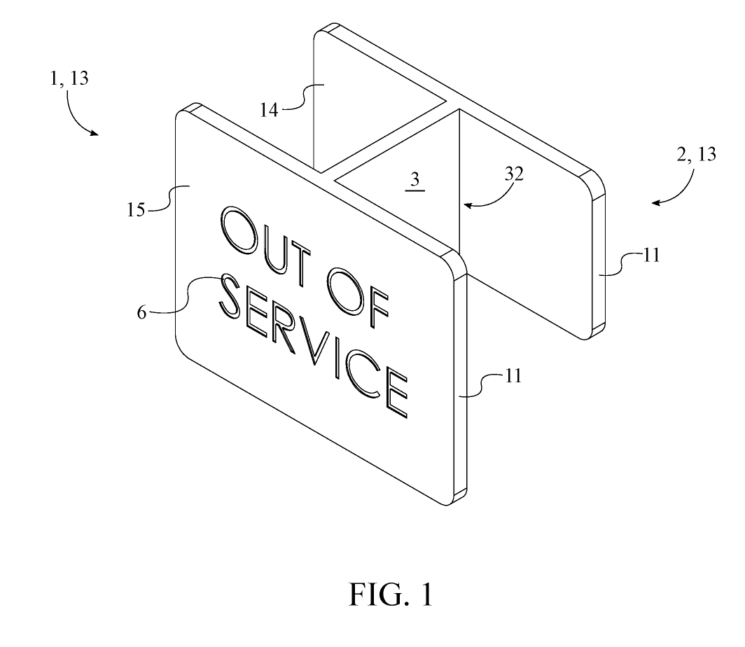

In reference to FIGS. 1 through 6, the present invention is a bathroom-stall door stop that prevents a user from utilizing an out-of-service bathroom stall. The present invention comprises a first panel 1, a second panel 2, and a cross plate 3. The first panel 1, the second panel 2, and the cross plate 3 form a structural body which prevents a bathroom stall from being opened by a user, through obstruction of the hinged connection between the bathroom stall door and frame. When the present invention is engaged to bathroom stall, the first panel 1 is positioned adjacent to the exterior of a bathroom-stall door, the second panel 2 is positioned adjacent to the interior of the bathroom-stall door, and the cross plate 3 is positioned adjacent to the hinged connection between the bathroom stall door and frame.

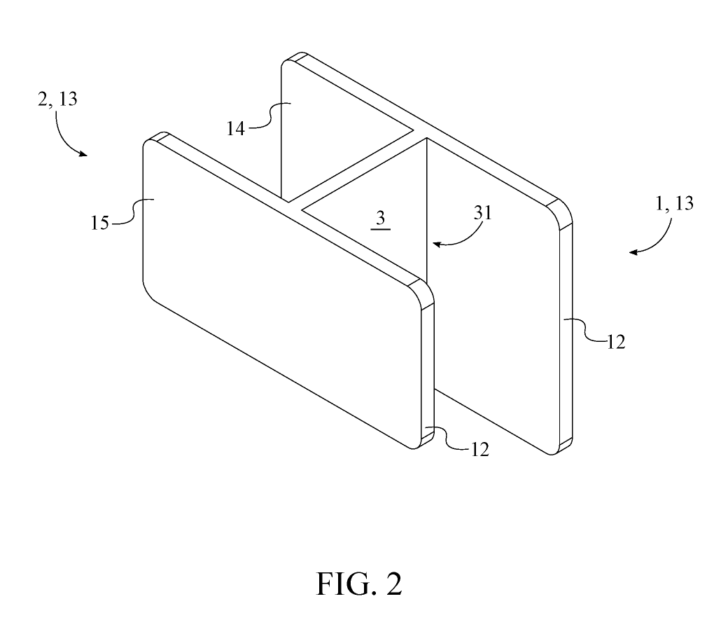

The general configuration of the aforementioned components allows the present invention to effectively prevent a user from entering an out of service bathroom stall. The first panel 1, the second panel 2, and the cross plate 3 may be composed of any material such as, but not limited to, plastic or acrylic. Furthermore, the present invention can be designed to match the design of the out of service bathroom stall. As seen in FIGS. 1 and 2, the first panel 1 and the second panel 2 each comprise a proximal face 14, a distal face 15, a panel body 13, a first panel edge 11, and a second panel edge 12. The cross plate 3 comprises a first plate edge 31 and a second plate edge 32 which are positioned opposite to each other across the cross plate 3. The first panel edge 11 and the second panel edge 12 are positioned opposite to each other across the panel body 13. The first plate edge 31 is mounted adjacent to the proximal face 14 of the first panel 1. The first plate edge 31 is positioned in between the first panel edge 11 of the first panel 1 and the second panel edge 12 of the first panel 1. The arrangement between the first panel 1 and the cross plate 3 creates a wedge to hold the bathroom-stall door shut from the inside. The second plate edge 32 is mounted adjacent to the proximal face 14 of the second panel 2. The second plate edge 32 is positioned in between the first panel edge 11 of the second panel 2 and the second panel edge 12 of the second panel 2. The arrangement between the second panel 2 and the cross plate 3 creates a wedge to hold the bathroom stall door shut from the outside.

As seen in FIGS. 1 and 2 and a more-specific arrangement of the first panel 1, the second panel 2, and the cross plate 3 further prevents present invention accidentally being removed or falling out from between the bathroom-stall door and frame. Moreover, this specific arrangement prevents the present invention from tilting to one side and being accidentally removed or falling out, consequently. Consequently, the first panel edge 11 of the first panel 1, the second panel edge 12 of the first panel 1, and the first plate edge 31 are positioned parallel to each other so that the first panel 1 is able to brace the bathroom-stall door and frame from the inside at the same vertical height. Similarly, the first panel edge 11 of the second panel 2, the second panel edge 12 of the second panel 2, and the second plate edge 32 are positioned parallel to each other so that the second panel 2 is able to brace the bathroom-stall door and frame from the inside at the same vertical height. In addition, the first panel edge 11 of the first panel 1 and the first panel edge 11 of the second panel 2 are positioned parallel to each other, which allows the first panel 1 and the second panel 2 to uniformly brace the bathroom-stall door from both sides. Likewise, the second panel edge 12 of the first panel 1 and the second panel edge 12 of the second panel 2 are positioned parallel to each other, which allows the first panel 1 and the second panel 2 to uniformly brace the bathroom-stall frame from both sides.

A more-specific arrangement of first panel 1, the second panel 3, and the cross plate 3 positions the center of gravity of the present invention at the cross plate 3. The first plate edge 31 is positioned equidistant between the first panel edge 11 of the first panel 1 and the second panel edge 12 of the first panel 1. Similarly, the second plate edge 32 is positioned equidistant between the first panel edge 11 of the second panel 2 and the second panel edge 12 of the second panel 2. This arrangement provides a center of gravity of the present invention, wherein the present invention will not naturally tilt to one side when placed in between a bathroom-stall door and frame.

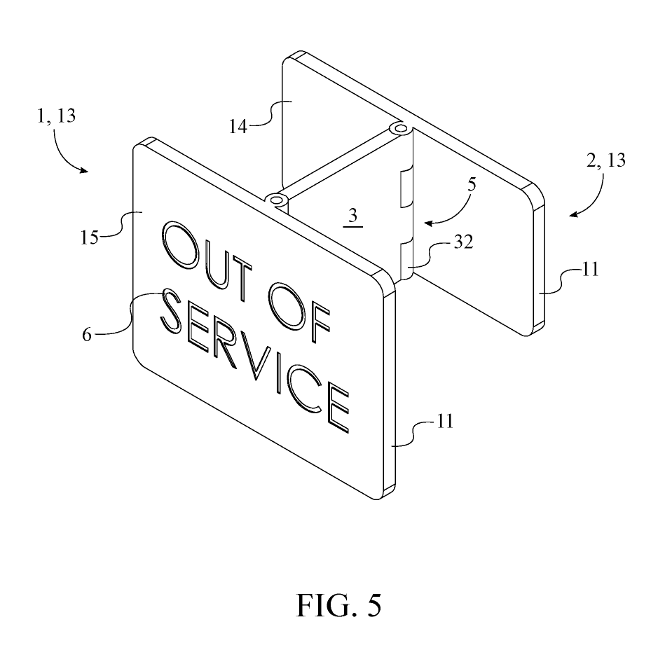

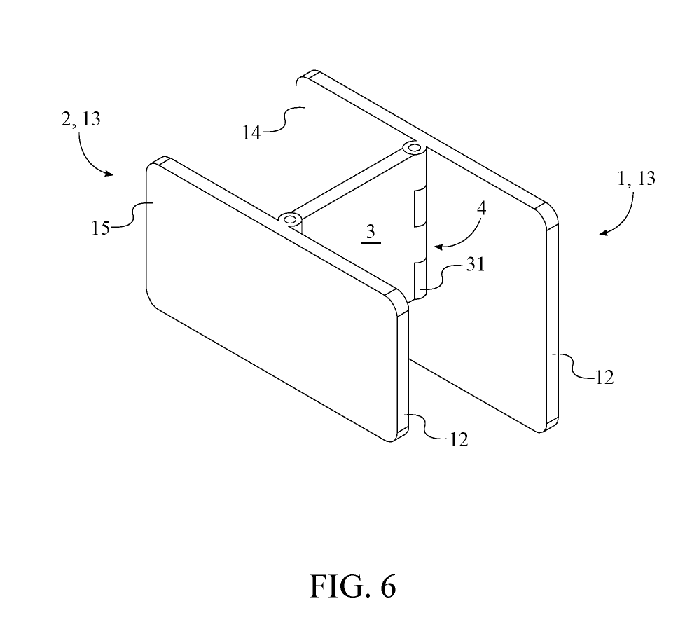

As seen in FIGS. 5 and 6, the present invention may further comprise a first hinge mechanism 4. The first hinge mechanism 4 is operatively integrated into the adjacent mounting between the first plate edge 31 and the proximal face 14 of the first panel 1, wherein the first hinge mechanism 4 is used to rotate the first panel 1 about the first plate edge 31. Likewise, the present invention may further comprise a second hinge mechanism 5. The second hinge mechanism 5 is operatively integrated into the adjacent mounting between the second plate edge 32 and the proximal face 14 of the second panel 2, wherein the second hinge mechanism 5 is used to rotate the second panel 2 about the second plate edge 32. This alternative embodiment and arrangement of components allows the present invention to be collapsible which further allows a person to easily store the present invention when not in use.

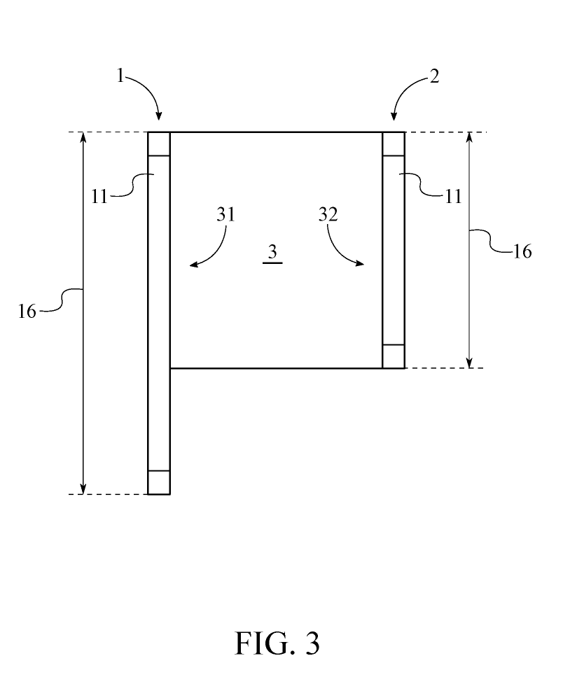

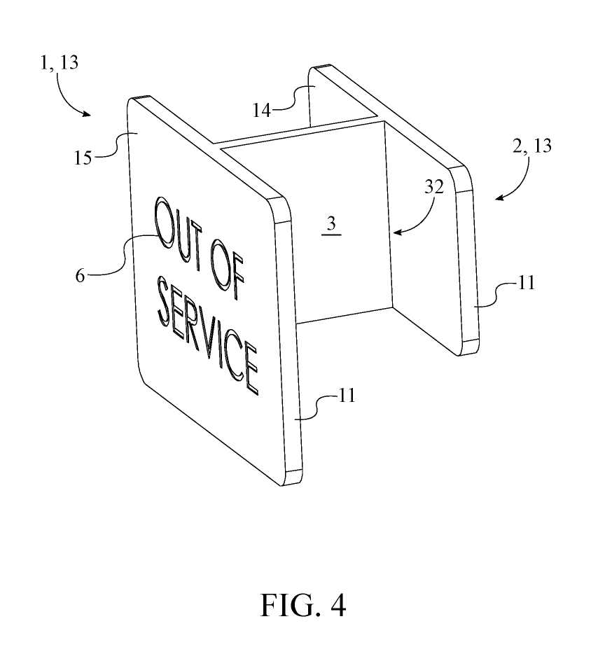

As seen in FIGS. 3 and 4, the first panel 1 and the second panel 2 each further comprise a height 16 in order to differentiate the first panel 1 from the second panel 2. The height 16 of the first panel 1 is positioned parallel to the first panel edge 11 of the first panel 1 and the second panel edge 12 of the first panel 1. The height 16 of the second panel 2 is positioned parallel to the first panel edge 11 of the second panel 2 and the second panel edge 12 of the second panel 2. The height 16 of the first panel 1 is greater than the height 16 of the second panel 2. This arrangement allows the user to visually distinguish the first panel 1 from the second panel 2 and this further allows the user to accurately position the present invention with a bathroom-stall door. The ratio between the height 16 of the first panel 1 and the height 16 of the second panel 2 is approximately 1.5 in order for the first panel 1 to be noticeably larger than the second panel 2 further allowing a user to distinguish the first panel 1 from the second panel 2.

As seen in FIGS. 1 and 5, the present invention may further comprise a visual indicator 6. The visual indicator 6 is inscribed into the distal face 15 of the first panel 1. The visual indicator 6 allows a person to read and figure out that a bathroom stall is out of service without attempting to open the bathroom-stall door. This arrangement allows a user to visually distinguish the first panel 1 from the second panel 2.

When the present invention is placed between a bathroom stall door and frame, the first panel 1, the second panel 2, and the cross plate 3 are in an operative configuration to prevent the entry of a person into the out-of-service bathroom stall. The first panel 1 and the second panel 2 are positioned parallel to each other. The cross plate 3 is positioned perpendicular to the first panel 1 and the second panel 2. This arrangement allows the present invention to be properly be centered when placed in between a bathroom-stall door and frame.

Although the invention has been explained in relation to its preferred embodiment, it is to be understood that many other possible modifications and variations can be made without departing from the spirit and scope of the invention as hereinafter claimed.

What is claimed is:

1. A bathroom-stall door stop comprises:
a first panel;
a second panel;
a cross plate;
the first panel and the second panel each comprise a proximal face, a distal face, a panel body, a first panel edge, and a second panel edge;
the cross plate comprises a first plate edge and a second plate edge;
the first plate edge and the second plate edge being positioned opposite to each other across the cross plate;
the first panel edge and the second panel edge being positioned opposite to each other across the panel body;
the first plate edge being mounted adjacent to the proximal face of the first panel;
the first plate edge being positioned in between the first panel edge of the first panel and the second panel edge of the first panel;
the second plate edge being mounted adjacent to the proximal face of the second panel; and
the second plate edge being positioned in between the first panel edge of the second panel and the second panel edge of the second panel.

2. The bathroom-stall door stop as claimed in claim 1 comprises:
the first panel edge of the first panel, the second panel edge of the first panel, and the first plate edge being positioned parallel to each other.

3. The bathroom-stall door stop as claimed in claim 1 comprises:
the first panel edge of the second panel, the second panel edge of the second panel, and the second plate edge being positioned parallel to each other.

4. The bathroom-stall door stop as claimed in claim 1 comprises:
the first panel edge of the first panel and the first panel edge of the second panel being positioned parallel to each other.

5. The bathroom-stall door stop as claimed in claim 1 comprises:
the second panel edge of the first panel and the second panel edge of the second panel being positioned parallel to each other.

6. The bathroom-stall door stop as claimed in claim 1 comprises:
the first plate edge being positioned equidistant between the first panel edge of the first panel and the second panel edge of the first panel.

7. The bathroom-stall door stop as claimed in claim 1 comprises:
the second plate edge being positioned equidistant between the first panel edge of the second panel and the second panel edge of the second panel.

8. The bathroom-stall door stop as claimed in claim 1 comprises:
a first hinge mechanism; and
the first hinge mechanism being operatively integrated into the adjacent mounting between the first plate edge and the proximal face of the first panel, wherein the first hinge mechanism is used to rotate the first panel about the first plate edge.

9. The bathroom-stall door stop as claimed in claim 1 comprises:
a second hinge mechanism; and
the second hinge mechanism being operatively integrated into the adjacent mounting between the second plate edge and the proximal face of the second panel, wherein the second hinge mechanism is used to rotate the second panel about the second plate edge.

10. The bathroom-stall door stop as claimed in claim 1 comprises:
a height of the first panel being positioned parallel to the first panel edge of the first panel and the second panel edge of the first panel;
a height of the second panel being positioned parallel to the first panel edge of the second panel and the second panel edge of the second panel; and
the height of the first panel being greater than the height of the second panel.

11. The bathroom-stall door stop as claimed in claim 10, wherein a ratio between the height of the first panel and the height of the second panel is approximately 1.5.

12. The bathroom-stall door stop as claimed in claim 1 comprises:
a visual indicator; and
the visual indicator being inscribed into the distal face of the first panel.

13. The bathroom-stall door stop as claimed in claim 1 comprises:
wherein the first panel, the second panel, and the cross plate are in an operative configuration;
the first panel and the second panel being positioned parallel to each other; and
the cross plate being positioned perpendicular to the first panel and the second panel.

14. A bathroom-stall door stop comprises:
a first panel;
a second panel;
a cross plate;
the first panel and the second panel each comprise a proximal face, a distal face, a panel body, a first panel edge, and a second panel edge;
the cross plate comprises a first plate edge and a second plate edge;
the first plate edge and the second plate edge being positioned opposite to each other across the cross plate;
the first panel edge and the second panel edge being positioned opposite to each other across the panel body;
the first plate edge being mounted adjacent to the proximal face of the first panel;
the first plate edge being positioned in between the first panel edge of the first panel and the second panel edge of the first panel;
the second plate edge being mounted adjacent to the proximal face of the second panel;
the second plate edge being positioned in between the first panel edge of the second panel and the second panel edge of the second panel;
the first panel edge of the first panel, the second panel edge of the first panel, and the first plate edge being positioned parallel to each other;
the first panel edge of the second panel, the second panel edge of the second panel, and the second plate edge being positioned parallel to each other;
the first panel edge of the first panel and the first panel edge of the second panel being positioned parallel to each other; and
the second panel edge of the first panel and the second panel edge of the second panel being positioned parallel to each other.

15. The bathroom-stall door stop as claimed in claim 14 comprises:
the first plate edge being positioned equidistant between the first panel edge of the first panel and the second panel edge of the first panel; and
the second plate edge being positioned equidistant between the first panel edge of the second panel and the second panel edge of the second panel.

16. The bathroom-stall door stop as claimed in claim 14 comprises:
a first hinge mechanism; and
the first hinge mechanism being operatively integrated into the adjacent mounting between the first plate edge and the proximal face of the first panel, wherein the first hinge mechanism is used to rotate the first panel about the first plate edge.

17. The bathroom-stall door stop as claimed in claim 14 comprises:
a second hinge mechanism; and
the second hinge mechanism being operatively integrated into the adjacent mounting between the second plate edge and the proximal face of the second panel, wherein the second hinge mechanism is used to rotate the second panel about the second plate edge.

18. The bathroom-stall door stop as claimed in claim 14 comprises:
a height of the first panel being positioned parallel to the first panel edge of the first panel and the second panel edge of the first panel;
a height of the second panel being positioned parallel to the first panel edge of the second panel and the second panel edge of the second panel; and
the height of the first panel being greater than the height of the second panel.

19. The bathroom-stall door stop as claimed in claim 18, wherein a ratio between the height of the first panel and the height of the second panel is approximately 1.5.

20. The bathroom-stall door stop as claimed in claim 14 comprises:
a visual indicator; and
the visual indicator being inscribed into the distal face of the first panel.
